(19) United States
(12) Patent Application Publication
(10) Pub. No.: US 2026/0247359 A1
(43) Pub. Date: Aug. 20, 2026

(54) UHR CRITICAL UPDATE ANNOUNCEMENT

(71) Applicant: NXP USA, Inc., AUSTIN, TX (US)

(72) Inventors: Liwen Chu, San Ramon, CA (US); Huizhao Wang, San Jose, CA (US); Hongyuan Zhang, Fremont, CA (US)

(21) Appl. No.: 19/543,524

(22) Filed: Feb. 18, 2026

Related U.S. Application Data
(60) Provisional application No. 63/759,766, filed on Feb. 18, 2025.
(60) Provisional application No. 63/775,599, filed on Mar. 21, 2025.

(51) Int. Cl. H04W 72/0446; H04W 76/15

(52) U.S. Cl. CPC H04W 72/0446; H04W 76/15

(57) ABSTRACT

Methods and apparatus are described for communicating critical update information between devices of a wireless network. In an embodiment, a first device (e.g., an access point) generates a (Beacon) frame including a critical update element carrying critical update information relating to an Ultra High Reliability (UHR) operation mode(s). The critical update element includes a countdown timer field that includes an indication of a time at which the critical update information becomes valid and a sub-element field carrying the critical update information for the UHR operation mode. The critical update information enables the UHR operation mode, disables the UHR operation mode, or updates one or more parameters of the UHR operation mode. The first device further transmits the frame for reception by at least one second device (e.g., a station affiliated with the access point).

### CROSS REFERENCE TO RELATED APPLICATIONS

The present U.S. Utility Patent Application claims priority pursuant to 35 U.S.C. § 119(e) to U.S. Provisional Application No. 63/759,766, entitled “UHR CRITICAL UPDATE”, filed Feb. 18, 2025, and U.S. Provisional Application No. 63/775,599, entitled “UHR CRITICAL UPDATE ANNOUNCEMENT”, filed Mar. 21, 2025, the contents of each of which is hereby incorporated herein by reference in its entirety and made part of the present U.S. Utility Patent Application for all purposes.

### TECHNICAL FIELD

This disclosure relates generally to wireless communications and more specifically to communication of critical update information between devices of a wireless network.

### BACKGROUND

Wireless local area networks (WLANs) have evolved rapidly over the past couple of decades, including WLANs that conform to the Institute of Electrical and Electronics Engineers (IEEE) 802.11 family of standards. An 802.11-based WLAN may be formed by one or more access points (APs) affiliated with one or more AP Multi-Link Devices (AP MLDs) that provide a shared wireless communication medium for servicing several client devices or stations (STAs) affiliated with one or more non-AP MLDs (or STA MLDs). In particular, an AP affiliated with an AP MLD manages a Basic Service Set (BSS) that is identified by a Basic Service Set Identifier (BSSID) and advertised by the AP. The AP periodically broadcasts beacon frames to enable STA MLDs within wireless range of the AP to establish and maintain communication links with the AP. Control information is used in a WLAN to manage and optimize such wireless communications.

Efforts are currently underway to develop next-generation MAC features/enhancements to support Ultra High Reliability (UHR) in IEEE 802.11.

### SUMMARY

The innovative methods and apparatus illustrated in the drawings and described herein relate to novel methods, element formats, frame formats and frame sequences to support new or revised MAC enhancements in the IEEE 802.11 standard. In an illustrative, non-limiting embodiment, a method for communicating critical update information between devices (e.g., access points) of a wireless network is provided. The method includes generating, by a first device, a frame including a critical update element carrying critical update information relating to an UHR operation mode or multiple UHR operation modes. The critical update element includes a countdown timer field that includes an indication of a time at which the critical update information becomes valid and a sub-element field carrying the critical update information for the UHR operation mode, wherein the critical update information enables the UHR operation mode, disables the UHR operation mode, or updates one or more parameters of the UHR operation mode. The method further includes transmitting the frame, by the first device, for reception by at least one second device.

The method of this embodiment includes optional aspects. With one optional aspect, the frame is a Beacon frame, a Multi-Link Probe Response frame, or a Probe Response frame. With another optional aspect, the time at which the critical update information becomes valid is specified in units of beacon intervals (BIs) that indicate a future Target Beacon Transmission Time (TBTT). In another optional aspect, the first device is an access point (AP) and the at least one second device is a station (STA) associated with the AP. In a further optional aspect, the sub-element field includes a mode ID field, a mode enable field providing a mode enable/disable indication, a mode update field, a mode length field, and a parameters field. With another optional aspect, the mode ID field carries a specified value corresponding to the UHR operation mode.

In another optional aspect, the frame further includes a link identification field that indicates at least one link for which the critical update information is applicable. In a further optional aspect, the link identification field carries a value of 15 to indicate that the critical update information relates to a Multi-Link Device (MLD) level link critical update. In yet another optional aspect, the method further includes transmitting, by the first device following the time at which the critical update information becomes valid, one or more additional frames in accordance with parameters included in the critical update information.

In another optional aspect, the first device is a first AP and the second device is a station (STA) associated with the AP and the frame further includes an enhanced critical update flag field set to 1. In yet another optional aspect, the frame further includes a capabilities information field, and the enhanced critical update flag field is included in the capabilities information field. With another optional aspect, the first device is a first access point (AP) affiliated with an access point Multi-Link Device (AP MLD), and the critical update information relates to an UHR operation mode of a second AP affiliated with the AP MLD.

In another optional aspect, the UHR operation mode is a Non-Primary Channel Access (NCPA) operation mode, a Dynamic Power Save (DPS) operation mode, a Dynamic Subband Operation (DSO) operation mode, or a Distributed Beamforming Enhancement (DBE) operation mode. In a further optional aspect, the critical update element relates to a first group of UHR operation mode(s), and the frame further includes a second critical update element relating to a second group of UHR operation mode(s). With another optional aspect, the frame further includes a second critical update element relating to the UHR operation mode for which the critical update information is applicable. In this optional aspect, the second critical update element includes a countdown timer field that carries a value of zero and a sub-element field carrying current operating information for the UHR operation mode.

With another illustrative, non-limiting embodiment, a method for communicating critical update information in a wireless network is provided. The method includes generating, by a first AP, a Beacon frame including a critical update element carrying critical update information relating to an UHR operation mode or multiple UHR operation modes. The critical update element includes a countdown timer field that includes an indication of a time at which the critical update information becomes valid and a sub-element field carrying the critical update information for the UHR operation mode, wherein the critical update information enables the UHR operation mode, disables the UHR operation mode, or updates one or more parameters of the UHR operation mode. In this embodiment, the sub-element field includes a mode enable field, a mode update field, and a parameters field. The method further includes transmitting, by the first AP, the Beacon frame for reception by a station (STA).

With another illustrative, non-limiting embodiment, a wireless device includes one or more wireless transceivers and a processor operably coupled to the one or more of wireless transceivers. The processor is arranged to generate a Beacon frame including a critical update element carrying critical update information relating to an UHR operation mode or multiple UHR operation modes. The critical update element includes a countdown timer field that includes an indication of a time at which the critical update information becomes valid, and a sub-element field carrying the critical update information for the UHR operation mode, wherein the critical update information enables the UHR operation mode, disables the UHR operation mode, or updates one or more parameters of the UHR operation mode. In this embodiment, the sub-element field includes a mode enable field, a mode update field, and a parameters field. The processor is further arranged to transmit, via the one or more wireless transceivers, the Beacon frame for reception by a second wireless device.

This third embodiment includes optional aspects. With one optional aspect, the time at which the critical update information becomes valid is specified in units of beacon intervals (BIs) that indicate a future Target Beacon Transmission Time (TBTT). In another optional aspect, the Beacon frame further includes a link identification field to indicate one or more links for which the critical update information is applicable, the link identification field carrying a value of 15 to indicate that the critical update information relates to a Multi-Link Device (MLD) level link critical update. In a further optional aspect, at least one of the wireless device or the second wireless device is an Access Point Multi-Link Device (AP MLD).

### BRIEF DESCRIPTION OF THE DRAWINGS

FIG. 1 illustrates an example of a multi-link communications system in accordance with embodiments of the present disclosure;

FIG. 2 illustrates an example of an AP Multi-Link Device in accordance with embodiments of the present disclosure;

FIG. 3 illustrates an example format of a Beacon frame including critical update information in accordance with embodiments of the present disclosure;

FIG. 4 illustrates an example of critical update element in accordance with an embodiment of the present disclosure;

FIG. 5 illustrates an example of a Beacon frame sequence for updating critical information in accordance with an embodiment of the present disclosure;

FIG. 6 is a flow chart illustrating an example method for communicating critical update information in accordance with an embodiment of the present disclosure; and

FIG. 7 illustrates an example of an AP/AP-MLD according to an embodiment of the present disclosure.

### DETAILED DESCRIPTION

Among other aspects, the implementations described herein relate generally to communicating (enhanced) critical update information between devices of a wireless network. More specifically, novel methods, element formats, frame formats and frame sequences are disclosed to support several new or revised MAC enhancements under consideration for the IEEE 802.11bn amendment to the IEEE 802.11 standard (also referred to as Ultra High Reliability or “UHR” or “Wi-Fi 8”) and future generations of the IEEE 802.11 standard.

Such MAC enhancements (also referred to herein as operating modes) may include, without limitation, Non-Primary Channel Access (NCPA), Dynamic Power Save (DPS), Dynamic Subband Operation (DSO), Distributed Beamforming Enhancement (DBE), Dynamic Unavailability Operation (DUO), etc. Briefly, NCPA allows compliant devices to switch to a secondary channel (NCPA primary channel) when a primary channel is busy to boost overall spectral efficiency. DPS allows a STA to dynamically switch between a low-capability (LC) mode and a higher-capability (HC) operating mode to save energy. DSO is a mechanism that adapts the allocation of sub-channels within a wide-band PPDU when client capabilities differ. DBE is a technique that allows an AP to extend its operating bandwidth (DBE BW) to a bandwidth that is wider than its BSS operating BW where the DBE BW can be used for information exchanges between the AP and STAs associated with the AP that enable DBE. DUO is a mechanism to solicit a TXOP responder's unavailable information or to report a TXOP holder's unavailability information without soliciting. Such features may rely on the timely and efficient exchange of critical update information between wireless devices (e.g., with advance notification prior to enabling a critical update). In the following description, various examples of the contents of a frame (e.g., a Beacon frame or (Multi-Link) Probe Response frame) are described for providing critical update information relating to one or more operating modes such as described above.

Various implementations of the subject matter described in the present disclosure can realize one or more of the following potential advantages. By improving and expanding support for next-generation MAC enhancements, the described methodologies help improve overall channel utilization, simplify multi-AP coordination, reduce contention and backoff delays, improve latency for real-time traffic, and facilitate device coexistence. In addition, the techniques described herein help enable gains in overall network throughput (particularly in high-density environments) that will be achievable in accordance with the IEEE 802.11bn amendment to the IEEE 802.11 standard.

As used herein, the term “non-legacy” may refer to frame formats and communication protocols conforming with the IEEE 802.11bn amendment to the IEEE 802.11 standard (“802.11bn”) as well as future generations/amendments. In contrast, the term “legacy” may be used herein to refer to frame formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard.

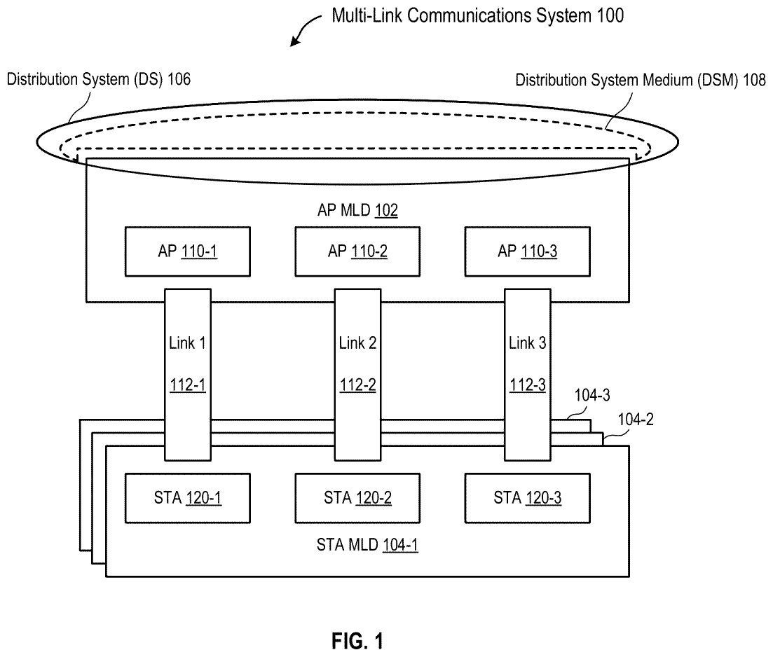

FIG. 1 illustrates an example of a multi-link (ML) communications system 100 in accordance with embodiments of the present disclosure. The illustrated multi-link communications system 100 includes at least one AP Multi-Link Device (AP MLD) 102 and one or more non-AP Multi-Link Devices (which may also be referred to herein as a “non-AP MLD” or “STA MLD”), which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities that are common to multiple links (e.g., association establishment, reordering of frames, etc.) and a link specific part of the AP MLD 102, i.e., the APs 110-1, 110-2, and 110-3, implement the upper layer functionalities specific to a link and lower layer MAC functionalities (e.g., beaconing, backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 102 may operate in the same different frequency bands. For example, at least one of the APs 110-1, 110-2, or 110-3 of the AP MLD 102 operates in an Extremely High Frequency (EHF) band or the “millimeter wave (mmWave)” frequency band. In some embodiments, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are affiliated with (i.e., part of) the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less than three communications links. In some embodiments, the wireless communications links in the multi-link communications system include one or more 2.4 GHz, 5 GHz, 6 GHz, 45 GHz and/or 60 GHz links. When a STA MLD is associated with an AP MLD, the STA affiliated with the STA MLD in link1 is associated with the AP affiliated with the AP MLD in link1.

As described above, a multi-link AP MLD has one or multiple links where each link utilizes one AP affiliated with the AP MPD. This may be accomplished by having different radios for different affiliated APs.

A multi-link STA MLD (or non-AP MLD) has one or multiple links where each link has one STA affiliated with the STA MLD. One way to implement the multi-link STA MLD is by using two or more radios, where each radio is associated with a specific link. For example, an multi-link multi-radio (MLMR) non-AP MLD may be used. The MLMR non-AP MLD uses multiple full functional radios to monitor the medium in multiple links. Another way to implement the multi-link STA MLD is by using a single radio in two different bands. Each band may be associated with a specific link. In this case, only one link is available at a time. In yet another implementation, an enhanced single-radio (ESR) STA MLD may be used that operates in an enhanced Multi-Link Single Radio (eMLSR) multi-link mode. In eMLSR, a device with a “single” radio interface can manage multiple links more efficiently than basic time-division multiplexing. For example, instead of switching the radio back and forth, an eMLSR STA MLD can use multiple receive chains to “listen” on several links simultaneously while also transmitting or receiving payload data on only one link at any given point in time.

As used herein, the term “critical update information” generally refers to essential, time-sensitive control data (e.g., parameters) that is expected to be delivered reliably and in a timely manner so coordinated multi-AP features can function correctly. In some examples, critical update information refers to information for a UHR critical update (including future enhancements/additions thereto). With respect to IEEE 802.11bn, any change that materially affects PHY/MAC operation (e.g., puncturing, spectrum use, non-primary channels, bandwidth expansion, etc.) in a manner that could break synchronization or cause transmissions to be misinterpreted may be classified as a UHR critical update. For UHR MAC enhancements such as NCPA, DPS, DSP and DBE and other modes of operation, it is often desirable to provide advance notification of critical update information (i.e., prior to a time that the critical update information is intended to be applied).

According to various embodiments described herein, an AP of an AP MLD (e.g., AP 110-1 of AP MLD 102) may announce that it has a UHR critical update to its associated STAs (e.g., STA 120-1 etc.) in a first link. In another example, an AP of the AP MLD (e.g., AP 110-1 of AP MLD 102) may announce a UHR critical update of another AP of the AP MLD (e.g., AP 110-2 of AP MLD 102), to its associated STAs (e.g., STA 120-2 etc. in a second link), via the first link. In a further example, an AP of an AP MLD (e.g., AP 110-1 of AP MLD 102) announces a UHR critical update of the AP MLD via the first link.

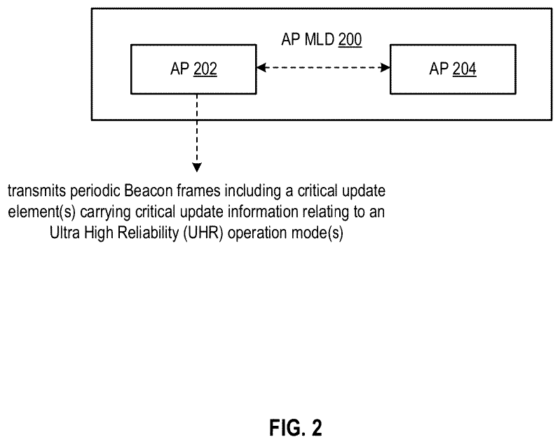

FIG. 2 illustrates an example of an AP Multi-Link Device (AP MLD) 200 in accordance with embodiments of the present disclosure. In this example, an AP 202 and an AP 204 of the AP MLD 200 implement one or more UHR operation modes. In this example, AP 202 and AP 204 are affiliated with AP MLD 200, such as the AP MLD 102 described with reference to FIG. 1.

In the illustrated example, AP 202 provides critical update information relating to one or more UHR operation modes of AP 202. In an example, the AP 202 transmits the critical update information for reception by one or more stations (STAs). The critical update information may function to enable, disable, or update one or more parameters of a particular UHR operation mode of AP 202. In another example, the AP 202 of AP MLD 200 provides critical update information of AP 204 via periodic Beacon frames or (Multi-Link) Probe Response frames that include one or more critical update elements. Such critical update information may be accepted by STAs associated with AP 204 through the STAs associated with AP 202. In a further example, AP 202 provides critical update information relating to one or more UHR operation modes of the AP MLD 200. In this example, a critical update may be accepted by a STA MLD through STAs associated with AP 202.

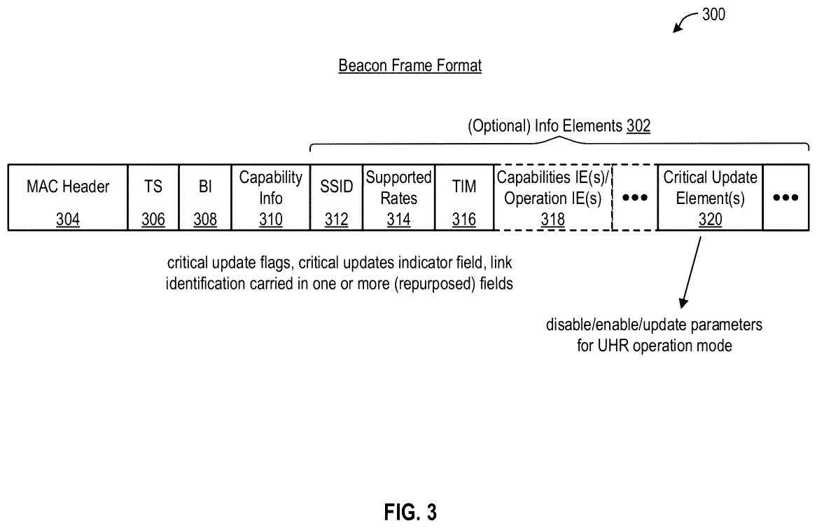

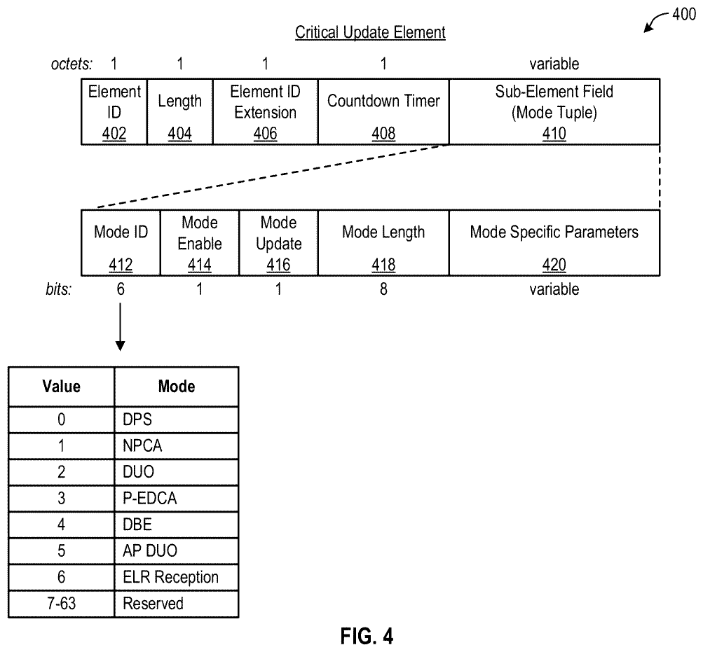

In another example, a critical update element(s) may be carried in a Probe Response frame or a Multi-Link Probe Response frame. An example of a Beacon frame including a critical update element is described in conjunction with FIG. 3. An example of a critical update element according to embodiments of the present disclosure is described in conjunction with FIG. 4.

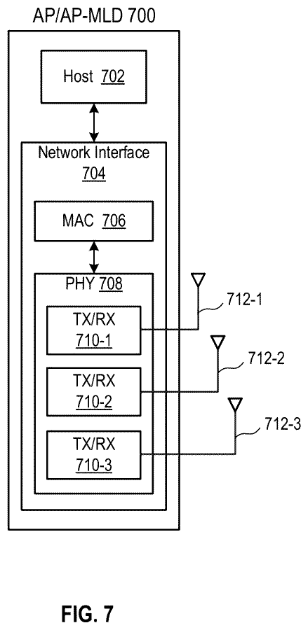

FIG. 3 illustrates an example format of a Beacon frame 300 including a critical update element carrying critical update information in accordance with embodiments of the present disclosure. The Beacon frame 300 is transmitted by an AP, such as an AP MLD described in conjunction with FIG. 1 or the AP/AP MLD 700 described with reference to FIG. 7.

Briefly, a Beacon frame is a type of management frame that is periodically transmitted by an AP to announce its presence and provide important network information to its associated STAs, nearby unassociated STAs and other APs. This information may include the network's BSSID (Basic Service Set Identifier), supported data rates, security parameters, and other configuration details. With respect to client devices, the Beacon frame provides information for devices to determine whether a network is within range and if it meets the device's connectivity requirements. In addition, the Beacon frame allows devices to synchronize with an AP's timing and channel. In some instances, a Beacon frame carries a UHR BSS operation element (e.g., a UHR Basic MCS and Nss set) and indications to enable various UHR features but may not always carry parameters for the various UHR features. For example, the parameters related to various UHR features such as NPCA parameters, DPS parameters, and DBE parameters, may not be carried in a Beacon frame if there is no critical update related to such UHR features. In the embodiments described herein, the critical update information related to UHR features may be (temporally) carried in several Beacon frames when a critical update(s) related to information of a UHR feature occurs (e.g., enabling, disabling, or updating the parameters of the UHR feature).

In the illustrated example, Beacon frame 300 includes a MAC Header 304 including control and addressing information, a Timestamp (TS) field 306 that carries the value (e.g., a 64-bit value) of an AP's local clock at time the Beacon frame is transmitted for synchronization and power save scheduling, a Beacon Interval (BI) field 308, and a Capability Info field 310. These fields are generally considered mandatory fields for a Beacon frame, which may further include a sequence of (optional) Information Elements (IEs) 302. The Information Elements 302 are formatted as Type-Length-Value fields.

In this example, the Information Elements 302 include an SSID field 312, a Supported Rates/Extended Rates field 314, a Traffic Indication Map (TIM) field 316, Capabilities/Operation IEs 318, and at least one critical update element 320. In some embodiments, the critical update element 320 is a sub-element carried in another element In an example, the critical update element 320 is a sub-element of a Basic Multi-Link element (MLE) (e.g., a Per STA Profile of the MLE). The critical update element 320 may be arranged to enable, disable, or update one or more parameters of a particular UHR operation mode. An example of a critical update element is described in conjunction with FIG. 4.

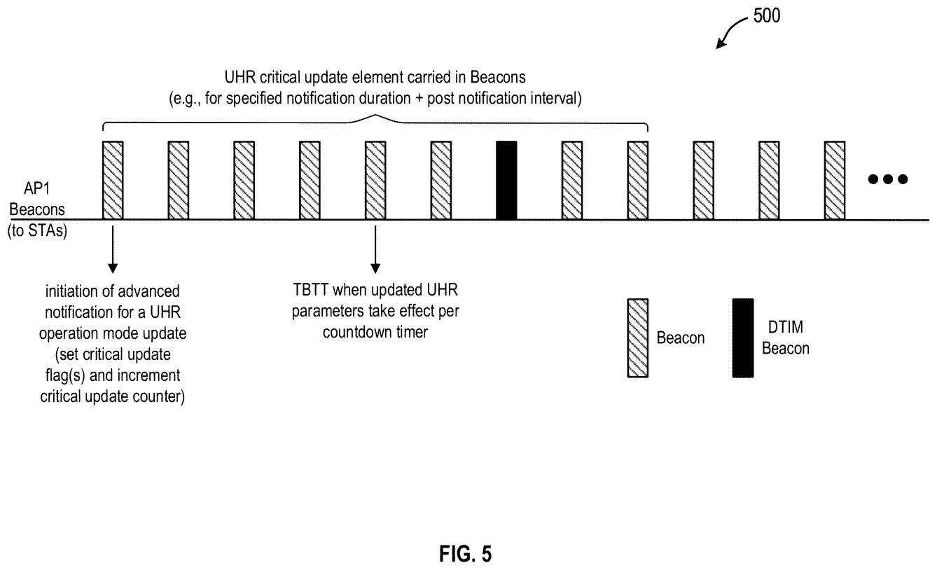

In various embodiments, one or more IEs 312-318 may be redefined or utilized to include various AP capabilities and operation parameters. In various embodiments, each of one or more critical update elements 320 includes critical update counters for critical update countdown/valid times, link identification information and the critical update information for one of multiple UHR operation modes where the information for each mode includes the operation type of the operation mode (e.g., one of NPCA, DPS, DBE, DSO, etc.), the length of the operation mode parameters (may be zero if there are no parameter updates), an indication(s) of enabling/disabling/updating an operation mode, and the operation mode parameters. In some embodiments, the Beacon frame 300 includes a link identification field that indicates at least one link for which the critical update information applicable, and the link identification field is carried in an element other than the critical update element 320. For example, a Link ID value may be carried in a Link ID subfield of a Per STA Profile in a Basic Multi-Link element (MLE) (not separately illustrated) in the Beacon frame 300. An MLE supports Multi-Link Operation (MLO), and generally contains a Common Info field, a Link Info field carrying Per STA Profile field(s) where each Per Station Profile field carries a STA Control field with a Link ID field and other fields, a STA Info field and a STA Profile field carrying link-specific capabilities and link-specific parameters. In an example, the Link ID subfield carries a value of 15 to indicate that the Per STA Profiled field carrying the Link ID field carries MLD level information (e.g., the critical update element in the Per STA Profile with a Link ID field equal to 15 carries a critical update of an AP MLD. In an example, when no UHR critical update occurs, the critical update element 320 is not carried in the Beacon frame 300. In another example, when a UHR critical related to one or multiple UHR operation modes occurs, one or multiple critical update elements 320 may be repeated in a sequence of Beacon frames as described in conjunction with FIG. 5.

FIG. 4 illustrates an example of critical update element 400 in accordance with an embodiment of the present disclosure. In this example, the critical update element 400 (which may also be referred to as a UHR Parameters Update element) includes an Element ID field 402, a Length field 404, an Element ID Extension field 406, a Countdown Timer field 408 and a sub-element field 410 including one or more “Mode Tuple” fields.

In the illustrated example, the Countdown Timer field 408 is set to indicate the time at which the critical update information included in a sub-element field 410 takes effect. In an example, the time is specified in units of beacon intervals (BIs) that indicate a future Target Beacon Transmission Time (TBTT). For example, a Countdown Timer field 408 value of 1 indicates that the critical update information becomes effective at the next TBTT. Other values (e.g., larger than specified value) may be used to indicate that the critical update information has already taken effect.

In another example, the Countdown Timer field 408 includes a timing synchronization function (TSF) timer value or a partial TSF timer value (e.g., for a MLD level critical update). With respect to a MLD level critical update applied to multiple links, in an example the effective time (or remaining BIs) is the time (or remaining BIs) of the link used to transmit the critical update element. In an example, the effective time is the indicated TBTT of a reference link. In a further example, the effective time (or remaining BIs) is the time (or remaining BIs) of the link with the minimal link ID value of a set of links to which a critical update is applied. In an example of an AP MLD level critical update where AP1 and AP2 are affiliated with the AP MLD and remaining BIs are used to indicate the time when the critical update happens, if AP1 announces the remaining BIs become 0 at AP1's TBTT (TBTT1), AP2 announces the remaining BIs become 0 at AP2's next TBTT that follows AP1's TBTT1.

The sub-element field 410 of the illustrated example includes a Mode ID field 412, a Mode Enable field 414, a Mode Update field 416, a Mode Length field 418, and a Mode Specific Parameters field 420. In an example, the Mode Enable field 414 indicates whether an AP (e.g., a reporting AP) intends to enable or disable an operation mode (“mode”) identified by the Mode ID field 412 at a TBTT indicated in the Countdown Timer field 408. In this example, the Mode Enable field 414 is set to 1 to enable the mode and is set to 0 to disable the mode. Continuing with this example, the Mode Update field 416 is set to 1 to indicate that the AP intends to update parameters for a mode that is already enabled and is otherwise set to 0. The Mode Length field 418 indicates the number of octets/length of the Mode Specific Parameters field 420. In a further example, the Mode Length field 418 and the Mode Specific Parameters field 420 may be omitted if the Mode Enable field 414 is set to 0.

In the illustrated embodiment, an example table is provided to show mode ID values (of Mode ID field 412) corresponding to different UHR modes operation. These values may be used to define the parameters carried in the Mode Specific Parameters field 420. In this example, a value of 0 in the Mode ID field 412 corresponds to DPS, a value of 1 corresponds to NCPA, a value of 2 corresponds to DUO, a value of 3 corresponds to Prioritized Enhanced Distributed Channel Access (P-EDCA), a value of 4 corresponds to DBE, a value of 5 corresponds to AP Trigger-Based Punctured UL OFDMA (AP PUO), a value of 6 corresponds to Extended Listen Interval Request (ELR) reception. In this example, the values 7-63 are reserved to accommodate future MAC enhancements.

In various examples, NPCA critical update information includes at least an NPCA Enabling/Disabling Indication, an NPCA primary channel, the NPCA switch delay that indicates AP's switch from primary channel to NPCA primary channel (e.g., in units of 4 us), the NPCA switch back delay that indicates AP's switch from NPCA primary channel to primary channel (e.g., in units of 4 us), an NPCA switch OBSS activity duration threshold. When the duration of OBSS activity detected in a primary channel is longer than the threshold, the AP/STA switches to NPCA primary channel.

DSO-related critical update information may include at least a DSO Enabling/Disabling Indication, the DSO subchannel location and bandwidth (e.g., in a bitmap with each bit corresponding to 20 MHz), and the DSO anchor channel for dynamic puncture operation.

DPS-related critical update information may include at least a DPS Enabling/Disabling Indication, a DPS padding delay (e.g., indicating the padding in units of 4 us for an AP's switch from a LC (low capability) mode to a HC (high capability) mode, a DPS transition delay indicating the transition time (e.g., in unit of 4 us) for an AP's switch from HC mode to LC mode. The DPS critical update of this example further includes a DPS OBSS activity duration threshold. When the duration of OBSS activity is longer than the threshold, an AP/STA can switch to a NPCA primary channel. In another example, the DPS critical update further indicates whether a client device's non-TB transmission is disallowed in the NPCA primary channel.

DBE-related critical update information may include at least the BW of DBE operation, the channel puncture bitmap, and the secondary 160 MHz channel location if the DBE BW is 320 MHz.

An AP's unavailable report (based on Broadcast TWT) critical update information (not separately illustrated) may include at least a start time, an interval, and a duration. In another example, the Broadcast TWT update procedure may optionally follow other methods than those described herein.

FIG. 5 illustrates an example of a Beacon frame sequence 500 transmitted by a first access point (AP1) to an associated station (STA) (or stations) to update critical information for a UHR operation mode in accordance with an embodiment of the present disclosure. In the illustrated example, a UHR critical update element is carried in a sequence of Beacon frames that includes a Delivery Traffic Indication Message (DTIM) Beacon frame. In various examples, the critical update information carried in the critical update element may relate to a critical update of AP1, a critical update of a second AP (AP2) where AP1 and AP2 are affiliated with the same access point Multi-Link device (AP MLD), and/or a critical update of the AP MLD.

In this example, AP1 transmits a first Beacon frame configured to indicate and communicate the critical update information. The Beacon frame includes a critical update element having a countdown timer field that includes an indication of a time at which the critical update information becomes valid (illustrated as a TBTT when updated UHR parameters take effect). The critical update element further includes a sub-element field carrying the critical update information for the UHR operation mode. This information is included in successive Beacon frames of the illustrated sequence for a specified notification duration plus a post notification interval.

In an example, critical update information can be indicated by a specific flag(s) (e.g., a critical update flag/enhanced critical update flag set to 1) within (redefined) fields of the Beacon frame. The use of such flags may enable recipient STAs to determine whether decoding of the entire Beacon frame is required. In an example, when a specific flag is set to 1, decoding of the entire Beacon frame is required to in order to acquire the UHR critical update information. In this example, when the specific flag is set to 0, decoding of the entire Beacon frame is not required. In another example, a reserved bit in a Capabilities Information field may be repurposed to act as flag for critical update information. In another example, an element of a Traffic Indication Map (e.g., a Partial Virtual Bitmap field) is defined as a critical updates indicator field. In a further example, a critical update counter field of the critical updates indicator field is incremented in the first Beacon frame.

In another example, when an AP updates its operating information for one of a DPS, NPCS or DSO operation mode, a Beacon frame (in a sequence of Beacon frames) includes two critical update elements having the same Element Extension ID value and carrying operating/critical update information related to the associated UHR operation mode. In this example, the first critical update element includes a countdown timer field that carries a value of zero and a sub-element field carrying current operating information for the indicated operation mode. The current operating information may be helpful, for example, to a device that has missed a prior Beacon frame(s) from the AP and needs to quickly synchronize communications. The second critical update element includes a countdown timer field that carries a value indicating a future time (e.g., TBTT) at which critical update information carried in its sub-element field becomes valid.

Continuing with this example, following each successive Beacon frame of the sequence the value of the countdown timer of the second critical update element is decreased by one (e.g., modulo 16). When this countdown timer reaches zero, the second critical update element becomes the only element being carried in related Management frames.

In another example, a Beacon frame may include a first critical update element relating to a first group of UHR operation mode(s) and a second critical update element(s) relating to another group of UHR operation mode(s).

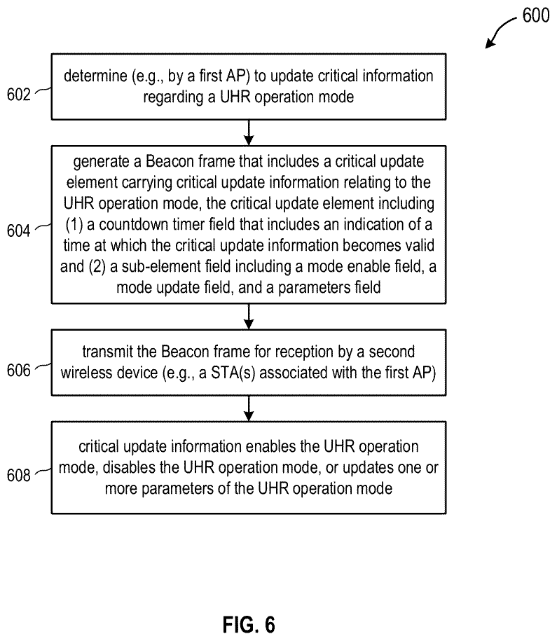

FIG. 6 is a flow chart illustrating an example method 600 for communicating critical update information in accordance with an embodiment of the present disclosure. The method 600 can be performed by an access point (AP), such as an AP affiliated with the AP MLD 102 described with reference to FIG. 1, or the wireless AP/AP MLD 700 described with reference to FIG. 7.

The illustrated method begins at step 602, where a first AP determines to update critical information regarding a UHR operation mode. The determination may be based, for example, on changing network conditions affecting an existing mode of operation or other considerations. The method continues at step 604, where the first AP generates a Beacon frame that includes a critical update element relating to the UHR operation mode. The Beacon frame may further include a link identification field that indicates at least one link for which the critical update element is applicable. In an example, a specified value (e.g., 15) is carried in the link identification field to indicate that the critical update information relates to a Multi-Link Device (MLD) level link critical update. In another example, the first AP broadcasts a second AP's critical update to STAs associated with the first AP. In this example, the Beacon frame may be transmitted by the first AP in a first link but carry critical update information for a second link of the second AP and a link identification field that indicates the second link. With the link indication, a STA1 associated with the first AP may notify a STA2 associated with the second AP when STA 1 and STA2 are affiliated with the same STA MLD.

The critical update element of the Beacon frame includes, for example, a countdown timer field that carries an indication of a time at which the critical update information becomes valid and a sub-element field including at least a mode enable field, a mode update field, and a parameters field. In an example, the time at which the critical update information of the critical update element becomes valid is specified in units of beacon intervals (BIs) that indicate a specific Target Beacon Transmission Time (TBTT). An example of a critical update element is described in greater detail with reference to FIG. 4.

The illustrated method continues at step 606 where the first AP transmits the Beacon frame for reception by an associated station (STA) or stations. The method proceeds to step 608 where, depending on the contents of the critical update element and sub-element field, the UHR operation mode between the first AP and its associated STA(s) is enabled, disabled, or updated/implemented with one or more updated parameters in accordance with the contents of the critical update element of the Beacon frame. In an example, following the time at which the critical update information becomes valid, the first AP transmits one or more additional frames in accordance with parameters included in the critical update information.

FIG. 7 illustrates an example of a wireless device that is configured as an access point (AP) or AP Multi-Link Device (AP MLD) according to an embodiment of the present disclosure. The AP/AP MLD 700 of this example is configurable to generate and transmit frames including critical update information according to any of the various embodiments described herein. The illustrated AP/AP MLD 700 includes a host processor 702 coupled to a network interface device 704. The network interface device 704 includes a medium access control (MAC) processing unit 706 and a physical layer (PHY) processing unit 708. The PHY processing unit 708 includes a plurality of transceivers 710 coupled to a plurality of antennas 712. Although three transceivers 710 (710-1, 710-2 and 710-3) and three antennas 712 (712-1, 712-2 and 712-3) are illustrated in FIG. 1, the AP/AP MLD 700 includes other suitable numbers (e.g., 1, 2, 4, 5, etc.) of transceivers 710 and antennas 712 in other embodiments. In an example, the MAC processing unit 706 and the PHY processing unit 708 are configured to operate in compliance with the IEEE 802.11bn amendment to the IEEE 802.11 standard. In an example, the network interface device 704 includes one or more integrated circuit (IC) devices. In this example, at least some of the functionality of the MAC processing unit 706 and at least some of the functionality of the PHY processing unit 708 can be implemented on a single IC device. As another example, at least some of the functionality of the MAC processing unit 706 is implemented on a first IC device, and at least some of the functionality of the PHY processing unit 708 is implemented on a second IC device. The AP/AP MLD 700 may communicate (e.g., C-TDMA related communications) with a plurality of client stations and/or APs, including both legacy and non-legacy client APs and stations.

In various embodiments, the PHY processing unit 708 of the AP/AP MLD 700 is configured to generate data units conforming to a non-legacy communication protocol and having formats described herein. The transceiver(s) 710 is/are configured to transmit the generated data units via the antenna(s) 712. Similarly, the transceiver(s) 710 is/are configured to receive data units via the antenna(s) 712. The PHY processing unit 708 of the AP/AP MLD 700 is configured to process received data units conforming to the non-legacy communication protocol and having formats described herein and to determine that such data units conform to the non-legacy communication protocol.

In an embodiment, when operating as an AP in single-user mode, the AP/AP MLD 700 transmits an ICF or data unit to a single client station (DL SU transmission) or receives an ICR or data unit transmitted by a single client station (UL SU transmission), without simultaneous transmission to, or by, any other client station. When operating in multi-user mode, the AP/AP MLD 700 transmits a data unit that includes multiple data streams for multiple client stations (DL MU transmission) or receives data units simultaneously transmitted by multiple client stations (UL MU transmission). For example, in multi-user mode, a data unit transmitted by the AP includes multiple data streams simultaneously transmitted by the AP/AP MLD 700 to respective client stations using respective spatial streams allocated for simultaneous transmission to the respective client stations and/or using respective sets of OFDM tones corresponding to respective frequency subbands allocated for simultaneous transmission to the respective client stations. In a further example, the AP/AP MLD 700 may be configured as a Multi-Link Device, such as the AP MLD 102 or STA MLD 104 described above with reference to FIG. 1.

While the innovative aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for communicating critical update information between devices of a wireless network, the method comprising:
generating, by a first device, a frame including a critical update element carrying critical update information relating to an Ultra High Reliability (UHR) operation mode or multiple UHR operation modes, wherein the critical update element includes:
a countdown timer field that includes an indication of a time at which the critical update information becomes valid; and
a sub-element field carrying the critical update information for the UHR operation mode, wherein the critical update information enables the UHR operation mode, disables the UHR operation mode, or updates one or more parameters of the UHR operation mode; and
transmitting the frame, by the first device, for reception by at least one second device.

2. The method of claim 1, wherein the frame is a Beacon frame, a Multi-Link Probe Response frame, or a Probe Response frame.

3. The method of claim 1, wherein the time at which the critical update information becomes valid is specified in units of beacon intervals (BIs) that indicate a future Target Beacon Transmission Time (TBTT).

4. The method of claim 1, wherein the first device is an access point (AP) and the at least one second device is a station (STA) associated with the AP.

5. The method of claim 1, wherein the sub-element field includes a mode ID field, a mode enable field providing a mode enable/disable indication, a mode update field, a mode length field, and a parameters field.

6. The method of claim 5, wherein the mode ID field carries a specified value corresponding to the UHR operation mode.

7. The method of claim 1, wherein the frame further includes a link identification field that indicates at least one link for which the critical update information is applicable.

8. The method of claim 7, wherein the link identification field carries a value of 15 to indicate that the critical update information relates to a Multi-Link Device (MLD) level link critical update.

9. The method of claim 1, further comprising:
transmitting, by the first device following the time at which the critical update information becomes valid, one or more additional frames in accordance with parameters included in the critical update information.

10. The method of claim 1, wherein the first device is a first access point (AP) and the second device is a station (STA) associated with the AP, and wherein the frame further includes an enhanced critical update flag field set to 1.

11. The method of claim 10, wherein the frame further includes a capabilities information field, and wherein the enhanced critical update flag field is included in the capabilities information field.

12. The method of claim 1, wherein the first device is a first access point (AP) affiliated with an access point Multi-Link Device (AP MLD), and wherein the critical update information relates to an UHR operation mode of a second AP affiliated with the AP MLD.

13. The method of claim 1, wherein the UHR operation mode is a Non-Primary Channel Access (NCPA) operation mode, a Dynamic Power Save (DPS) operation mode, a Dynamic Subband Operation (DSO) operation mode, or a Distributed Beamforming Enhancement (DBE) operation mode.

14. The method of claim 1, wherein the critical update element relates to a first group of UHR operation mode(s), and wherein the frame further includes a second critical update element relating to a second group of UHR operation mode(s).

15. The method of claim 1, wherein the frame further includes a second critical update element relating to the UHR operation mode for which the critical update information is applicable, the second critical update element including:
a countdown timer field that carries a value of zero; and
a sub-element field carrying current operating information for the UHR operation mode.

16. A method for communicating critical update information in a wireless network, the method comprising:
generating, by a first access point (AP), a Beacon frame including a critical update element carrying critical update information relating to an Ultra High Reliability (UHR) operation mode or multiple UHR operation modes, wherein the critical update element includes:
a countdown timer field that includes an indication of a time at which the critical update information becomes valid; and
a sub-element field carrying the critical update information for the UHR operation mode, wherein the critical update information enables the UHR operation mode, disables the UHR operation mode, or updates one or more parameters of the UHR operation mode, and wherein the sub-element field includes a mode enable field, a mode update field, and a parameters field; and
transmitting, by the first AP, the Beacon frame for reception by a station (STA).

17. A wireless device, comprising:
one or more wireless transceivers; and
a processor operably coupled to the one or more wireless transceivers, wherein the processor is arranged to:
generate a Beacon frame including a critical update element carrying critical update information relating to an Ultra High Reliability (UHR) operation mode or multiple UHR operation modes, wherein the critical update element includes:
a countdown timer field that includes an indication of a time at which the critical update information becomes valid; and
a sub-element field carrying the critical update information for the UHR operation mode, wherein the critical update information enables the UHR operation mode, disables the UHR operation mode, or updates one or more parameters of the UHR operation mode, and wherein the sub-element field includes a mode enable field, a mode update field, and a parameters field; and
transmit, via the one or more wireless transceivers, the Beacon frame for reception by a second wireless device.

18. The wireless device of claim 17, wherein the time at which the critical update information becomes valid is specified in units of beacon intervals (BIs) that indicate a future Target Beacon Transmission Time (TBTT).

19. The wireless device of claim 17, wherein the Beacon frame further includes a link identification field to indicate one or more links for which the critical update information is applicable, the link identification field carrying a value of 15 to indicate that the critical update information relates to a Multi-Link Device (MLD) level link critical update.

20. The wireless device of claim 17, wherein the wireless device is an access point (AP) and the second wireless device is a station (STA) associated with the AP.
